(19) United States
(12) Patent Application Publication
(10) Pub. No.: US 2022/0144091 A1
(43) Pub. Date: May 12, 2022

(54) LCD COLOR COMPENSATION BASED ON TEMPERATURE FOR HEADS UP DISPLAY

(71) Applicant: Panasonic Automotive Systems Company of America, Division of Panasonic Corporation of North America, Peachtree City, GA (US)

(72) Inventors: PATRICK O'CONNELL, NOVI, MI (US); EDO OMANOVIC, LIVONIA, MI (US)

(21) Appl. No.: 17/523,019

(22) Filed: Nov. 10, 2021

Related U.S. Application Data
(60) Provisional application No. 63/112,786, filed on Nov. 12, 2020.

(51) Int. Cl. B60K 37/02

(52) U.S. Cl. CPC B60K 37/02; B60K 2370/52; B60K 2370/1529; B60K 2370/23; B60Y 2200/00; B60K 2370/1523; B60K 2370/332; B60K 2370/48

(57) ABSTRACT

A head up display arrangement for a motor vehicle includes a light emitting element emitting a light field containing an image visible to a human driver of the motor vehicle. A temperature sensing device is positioned in association with the light emitting element. The temperature sensing device detects a temperature indicative of a temperature of the light emitting element, and transmits a temperature signal indicative of the detected temperature. An electronic processor is communicatively coupled to the light emitting element and the temperature sensing device. The electronic processor receives the temperature signal, and controls the light emitting element dependent upon the received temperature signal.

### CROSS-REFERENCED TO RELATED APPLICATIONS

This application claims benefit of U.S. Provisional Application No. 63/112,786, filed on Nov. 12, 2020, the disclosure of which is hereby incorporated by reference in its entirety for all purposes.

### BACKGROUND OF THE INVENTION

### 1. Field of the Invention

The present invention relates to a head up display (HUD) of a motor vehicle.

### 2. Description of the Related Art

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

HUD systems get very hot in the area of the picture generation unit (PGU). This is the area that houses the light emitting diodes (LEDs) and liquid crystal display (LCD). This high heat can shift the color to an undesirable degree. As temperature changes, the shade of each of the primary colors produced in the display (red, green, blue) also changes. All color in the LCD is based on a mixture or sum of these three primary colors.

As the temperature of LEDs and the LCD rise, the color coordinates for both the LEDs and LCD change due to this temperature increase. These changes cause the color of the image that is seen by the driver to shift. A bright white color may shift towards more of a reddish white, bluish white or greenish white based on the mixture of the red, green, and blue on the LCD.

### SUMMARY OF THE INVENTION

As the temperature of an LCD rises, the invention enables the mixture of primary colors to be adjusted to keep all produced colors constant. More particularly, the invention may provide a thermistor near the LCD and LEDs that relays the temperature back to the printed circuit board (PCB) that controls the color mixture of the image. Using this thermistor, the color mixture may be adjusted as the temperature changes. This enables the image color to stay stable throughout the temperature range.

The thermistor may be located either on the LED PCB or on the LCD glass. The thermistor may be located in other areas as long as the thermistor is measuring a temperature that is correlated to the temperature of the LCD and/or LEDs.

While the invention can be applied to all LCDs, a HUD may put the highest thermal load on the LCD, thereby causing a large change in the color coordinates needed to produce a desired color.

The invention comprises, in one form thereof, a head up display arrangement for a motor vehicle. The arrangement includes a light emitting element emitting a light field containing an image visible to a human driver of the motor vehicle. A temperature sensing device is positioned in association with the light emitting element. The temperature sensing device detects a temperature indicative of a temperature of the light emitting element, and transmits a temperature signal indicative of the detected temperature. An electronic processor is communicatively coupled to the light emitting element and the temperature sensing device. The electronic processor receives the temperature signal, and controls the light emitting element dependent upon the received temperature signal.

The invention comprises, in another form thereof, a method of operating a head up display in a motor vehicle, including emitting a light field including an image visible to a human driver of the motor vehicle. The emitting is performed by a light emitting element. A temperature indicative of a temperature of the light emitting element is detected. A temperature signal indicative of the detected temperature is transmitted. The temperature signal is received. The light emitting element is controlled dependent upon the received temperature signal.

The invention comprises, in yet another form thereof, a head up display arrangement for a motor vehicle including a red-light emitting diode, a green-light emitting diode, and a blue-light emitting diode. The red-light emitting diode, the green-light emitting diode, and the blue-light emitting diode conjunctively emit a light field including an image visible to a human driver of the motor vehicle. A thermistor is positioned in association with at least one of the light emitting diodes. The thermistor detects a temperature indicative of a temperature of the at least one light emitting diode, and transmits a temperature signal indicative of the detected temperature. An electronic processor is communicatively coupled to each of the light emitting diodes and the thermistor. The electronic processor receives the temperature signal, and controls the light emitting diodes dependent upon the received temperature signal to adjust at least one color in the emitted light field.

An advantage of the invention is that, as heads up displays get brighter and brighter, color compensation may maintain stable colors in the image presented to the driver.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a head up display color compensation arrangement of the present invention.

FIG. 2 is a schematic side view of one embodiment of the HUD picture generation unit (PGU) of FIG. 1.

FIG. 3 is a flow chart of one embodiment of a method of the present invention for operating a head up display in a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

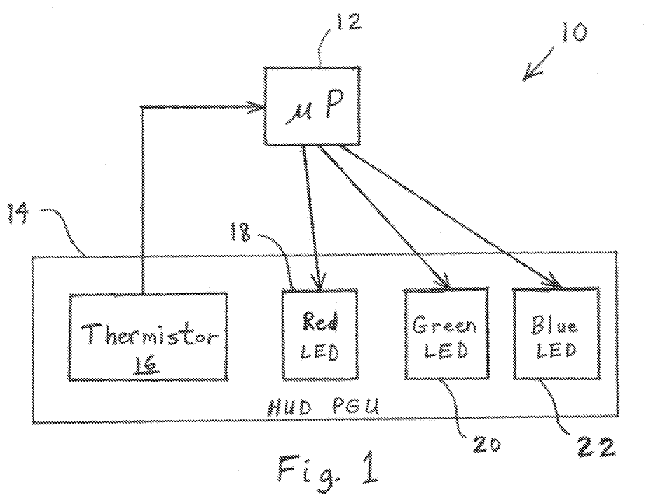

FIG. 1 illustrates one embodiment of a head up display color compensation arrangement 10 of the present invention including an electronic processor 12 and a heads up display (HUD) picture generation unit (PGU) 14. PGU 14 includes at least one thermistor 16, a red LED 18, a green LED 20, and a blue LED 22.

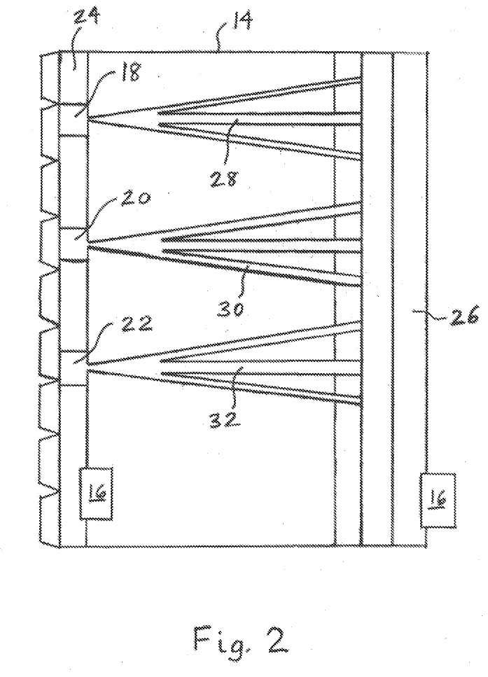

FIG. 2 illustrates PGU 14 in greater detail, including a printed circuit board (PCB) 24 and LCD glass sheet 26. Red LED 18, green LED 20, and blue LED 22 are disposed on PCB 24. A thermistor 16 may be disposed on PCB 24 and/or a thermistor 16 may be disposed on LCD glass sheet 26.

During operation, red LED 18, green LED 20, and blue LED 22 emit red light 28, green light 30, and blue light 32, respectively, onto LCD glass 26. Thus, red LED 18, green LED 20, and blue LED 22 conjunctively produce a light field that passes through LCD glass 26 and is reflected off of one or more mirrors (not shown) and then off of a vehicle windshield (not shown) so as to be visible to a human driver as a virtual image, as is conventionally known.

Thermistor(s) 16 may transmit signals to processor 12 indicative of the temperature of PCB 24 and/or LCD glass 26. Processor 12 may have access to a lookup table in memory that specifies what signals should be sent by processor 12 to red LED 18, green LED 20, and blue LED 22 for every possible temperature signal that may be received from thermistor(s) 16. Using the lookup table, processor 12 may transmit temperature-corrected or temperature-compensated signals to red LED 18, green LED 20, and blue LED 22. Thus, the color mixture at the surface of LCD glass 26 may be adjusted by processor 12 depending upon temperature signals received by processor 12 from thermistor(s) 16.

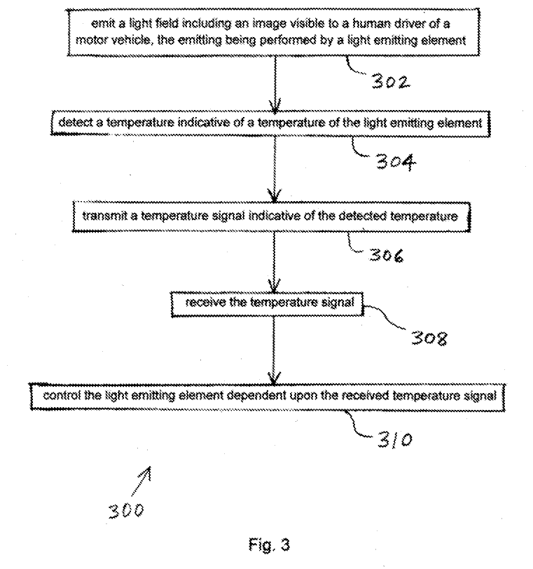

FIG. 3 illustrates one embodiment of a method 300 of the present invention for operating a head up display in a motor vehicle. In a first step 302, a light field is emitted including an image visible to a human driver of the motor vehicle. The emitting is performed by a light emitting element. For example, red light emitting diode 18, green light emitting diode 20, and blue light emitting diode 22 conjunctively emit a light field that is visible to a human driver as a virtual image.

Next, in step 304, a temperature indicative of a temperature of the light emitting element is detected. For example, thermistor(s) 16 may detect temperatures indicative of the temperature of red light emitting diode 18, green light emitting diode 20, and/or blue light emitting diode 22.

In a next step 306, a temperature signal indicative of the detected temperature is transmitted. For example, thermistor(s) 16 may transmit signals to processor 12 indicative of the temperature of red light emitting diode 18, green light emitting diode 20, and/or blue light emitting diode 22.

In step 308, the temperature signal is received. For example, processor 12 may receive the signals transmitted by thermistor(s) 16.

In a final step 310, the light emitting element is controlled dependent upon the received temperature signal. For example, processor 12 may transmit temperature-corrected or temperature-compensated signals to red LED 18, green LED 20, and blue LED 22. Thus, the operations of red LED 18, green LED 20, and blue LED 22 may be adjusted by processor 12 depending upon temperature signals received by processor 12 from thermistor(s) 16.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A head up display arrangement for a motor vehicle, the arrangement comprising:
a light emitting element configured to emit a light field including an image visible to a human driver of the motor vehicle;
a temperature sensing device positioned in association with the light emitting element and configured to:
detect a temperature indicative of a temperature of the light emitting element; and
transmit a temperature signal indicative of the detected temperature; and
an electronic processor communicatively coupled to the light emitting element and the temperature sensing device, the electronic processor being configured to:
receive the temperature signal; and
control the light emitting element dependent upon the received temperature signal.

2. The arrangement of claim 1, wherein the light emitting element comprises a light emitting diode.

3. The arrangement of claim 1, wherein the light emitting element comprises a liquid crystal display.

4. The arrangement of claim 1, wherein the electronic processor is configured to control the light emitting element such that colors in the light field do not change with temperature.

5. The arrangement of claim 1, wherein the temperature sensing device comprises a thermistor.

6. The arrangement of claim 1, further comprising a printed circuit board, wherein the light emitting element and the temperature sensing device are both mounted on the printed circuit board.

7. The arrangement of claim 1, wherein the light emitting element comprises a liquid crystal display including a sheet of glass, the temperature sensing device being mounted on the sheet of glass.

8. A method of operating a head up display in a motor vehicle, the method comprising:
emitting a light field including an image visible to a human driver of the motor vehicle, the emitting being performed by a light emitting element;
detecting a temperature indicative of a temperature of the light emitting element;
transmitting a temperature signal indicative of the detected temperature;
receiving the temperature signal; and
controlling the light emitting element dependent upon the received temperature signal.

9. The method of claim 8, wherein the light emitting element comprises a light emitting diode.

10. The method of claim 8, wherein the light emitting element comprises a liquid crystal display.

11. The method of claim 8, wherein the light emitting element is controlled such that colors in the light field do not change with temperature.

12. The method of claim 8, wherein the detecting is performed by a thermistor.

13. The method of claim 8, further comprising mounting the light emitting element and a temperature sensing device on a printed circuit board.

14. The method of claim 8, wherein the light emitting element comprises a liquid crystal display including a sheet of glass, the method further comprising mounting a temperature sensing device on the sheet of glass.

15. A head up display arrangement for a motor vehicle, the arrangement comprising:
a red-light emitting diode;
a green-light emitting diode;
a blue-light emitting diode, the red-light emitting diode, the green-light emitting diode, and the blue-light emitting diode being conjunctively configured to emit a light field including an image visible to a human driver of the motor vehicle;
a thermistor positioned in association with at least one of the light emitting diodes and configured to:
detect a temperature indicative of a temperature of the at least one light emitting diode; and
transmit a temperature signal indicative of the detected temperature; and
an electronic processor communicatively coupled to each of the light emitting diodes and the thermistor, the electronic processor being configured to:
receive the temperature signal; and
control the light emitting diodes dependent upon the received temperature signal to adjust at least one color in the emitted light field.

16. The arrangement of claim 15, further comprising a liquid crystal display.

17. The arrangement of claim 16, wherein the liquid crystal display includes a sheet of glass, the thermistor being mounted on the sheet of glass.

18. The arrangement of claim 15, wherein the electronic processor is configured to control the light emitting diodes such that at least one color in the emitted light field does not change with the detected temperature.

19. The arrangement of claim 15, further comprising a printed circuit board, wherein the light emitting diodes and the thermistor are mounted on the printed circuit board.

20. The arrangement of claim 15, further comprising at least one mirror and a windshield, the at least one mirror and the windshield being positioned to reflect the emitted light field toward the human driver.
